(19) United States
(12) Patent Application Publication
(10) Pub. No.: US 2011/0231995 A1
(43) Pub. Date: Sep. 29, 2011

(54) PATIENT POSITIONING DEVICE AND METHOD FOR OBTAINING BENT KNEE X-RAY VIEWS

(75) Inventor: Robert A. Sedillo, Alburquerque, NM (US)

(73) Assignee: XIC Services, LLC, Albuquerque, NM (US)

(21) Appl. No.: 13/054,821

(22) PCT Filed: Feb. 12, 2010
(86) PCT No.: PCT/US10/24044

§ 371 Date: Jan. 19, 2011

(51) Int. Cl. A61G 13/12

(52) U.S. Cl. 5/601

(57) ABSTRACT

A method and device for positioning a patient in order to obtain x-ray views of one or both of the patient's knees comprising a generally horizontal surface for supporting the patient; a radiolucent leg support in the general shape of a triangle whereby one line segment of the triangle supports the patient's lower leg, another line segment of the triangle supports the patient's upper leg, and the vertex created by the two line segments determines the angle of flexion of the patient's knee when the patient's leg is supported by the radiolucent leg support; a means for holding a cassette in a vertical position such that a Merchant's View of the patient's knee can be obtained; a means for holding a cassette in a horizontal position such that a Bent Knee AP View of the patient's knee can be obtained; and a means for holding a cassette in a vertical position such that a Bent Knee Lateral View of the patient's knee can be obtained.

### FIELD OF THE INVENTION

The present invention relates to a device and method of positioning a patient in order to obtain bent knee x-ray views of the patient's knees.

### BACKGROUND OF THE INVENTION

Plain radiography, or plain film x-ray imaging, is an effective tool for diagnosing medical problems, especially problems related to the human skeleton. To evaluate a particular part of the body, the patient and x-ray tube must be carefully positioned relative to each other in order to produce the best view of the particular body part. Some positions are difficult to achieve without the help of a positioning device like the present invention.

Four x-ray procedures in particular require complicated positioning that can cause stress and pain to a patient's back, neck, knees or hips, and increased exposure to radiation. The first view is commonly known as the Merchant's View, the second view is commonly known as the Sunrise View, the third view is the Bent Knee Anteroposterior (AP), or front-to-back, View, and the fourth view is the Bent Knee Lateral, or side-to-side, View. It is often the case that all of these views are needed for an accurate and thorough diagnosis. Repositioning the patient for each view of this series of knee views is time Consuming and can cause additional pain and discomfort for the patient.

The Merchant's View demonstrates the anatomy of the distal femoral sulcus and the patella (knee cap) in an approximately 45 degree flexion of the knee and allows measurement of the depth of the distal femoral sulcus in the functional range of the patellofemoral joint. Other views may show the shape of the patella but do not show the important relationship between the patella and its articulation with the distal femoral sulcus in flexion where dislocations or subluxations occur. The distal femoral sulcus can have dysplasia which can only be seen in the knee flexion position of the Merchant's View. To obtain this view, an x-ray beam is projected horizontally 10 to 15 degrees below the horizontal axis of the patient. The x-ray beam is preferably directed toward the patient's patella from the cranial aspect to caudal the aspect (the cranial aspect of a bone is the portion that is toward the head while the caudal aspect of a bone is the portion that is toward the feet). The x-ray beam is projected onto a cassette containing a radiation receptor, such as an x-ray film or an imaging plate, or any other from of radiation-absorbing media (hereinafter “cassette”). The cassette is in a vertical position, generally perpendicular to the x-ray beam. As used hereinafter, “Merchant's View” is defined as the view that demonstrates the anatomy of the distal femoral sulcus and the patella in an approximately 45 degree flexion of the knee.

The Sunrise View demonstrates the inverted mountain of the patella riding in the valley of the trochlear groove in an approximately 45 degree flexion of the knee. The positioning of the patient is similar to that of a Merchant's View except that the locations of the x-ray tube and the cassette are horizontally rotated approximately 180 degrees so that the x-ray beam is directed toward the patient's patella from the caudal aspect to the cranial aspect. As used hereinafter, “Sunrise View” is defined as the view that demonstrates the inverted mountain of the patella riding in the valley of the trochlear groove.

The Bent Knee AP View is obtained by placing a cassette in a horizontal position below the approximately 45 degree flexion point of the patient's knees and pointing the x-ray beam from above the patient so that the x-ray beam travels in a downward direction through the knee or knees toward the cassette. The view obtained by this positioning allows several measurements to be taken, including the width of the intercondylar space, which is important to determine since narrowness, either congenital or from traumatic changes, increases the chance of a rupture of the anterior cruciate ligament with a rotary motion. Another use of the Bent Knee AP View is to find loose bodies, which can be in the intercondylar notch and not seen using other views of the knee because of the overlying femoral bone. As used hereinafter, “Bent Knee AP View” is defined as the Anteroposterior, or front-to-back, view of the bent knee.

The Bent Knee Lateral View demonstrates the knee joint, or the junction of the femur (thigh bone), patella, and tibia (shin bone), and fibula, from the side. The view is obtained by placing a cassette in the vertical position on the medial side, or inside, of the patient's knees and pointing the x-ray central beam from the lateral side, or outside, of the knee such that it is generally perpendicular to the cassette. As used hereinafter, “Bent Knee Lateral View” is defined as the lateral, or side-to-side, view of the bent knee.

These and other approximately 45 degree bent knee views of the knee joint are used by orthopedic surgeons, emergency room doctors, geriatrics doctors, and others since only in this position can small avulsion fractures of the medial patellar retinaculum away from the medial facet of the patella be seen. Further, only in this position can the presence or absence of dysplasia of the distal femoral sulcus be determined. Finally, only with this view can the rotation of the patella in approximately 45 degrees of knee flexion be seen accurately, which is a much more functional position than can be seen in other views.

Unfortunately, in order to efficiently obtain these views, the patient or another person is usually required to hold the cassette in place, which causes additional radiation exposure to the person holding the cassette. Further, when more than one view of the knee is required, the patient must be repositioned for each view, which can be extremely difficult and detrimental for patients who are unable to cooperate for whatever reason, for instance if the patient is unconscious or in trauma, if the patient is elderly with fragile bones and low joint mobility, or if the patient is mentally impaired.

Therefore, it is important to be able to quickly, easily and safely position a patient so that bent knee views can be obtained. While there are examples in the prior art of x-ray positioning devices, none have the advantages of the present invention.

For instance, U.S. Pat. No. 4,700,373 to Miller discloses a platform comprised of upper and lower leg supports which are angled relative to each other at a fixed angle of 40 degrees. The patient lies in a supine position with one leg flexed by the platform. Means are provided for positioning an x-ray film cassette parallel to a plane bisecting the apex of the supports.

U.S. Patent Application No. 2005/0089147 to Cantacessi discloses a cassette support capable of holding film cassettes, providing a frontal knee x-ray or side or rear view, without having the patient involved in holding the cassette.

U.S. Pat. No. 7,434,993 to Rice discloses a device for supporting a radiographic cassette during the taking of a knee x-ray, which allows the patient to lie in a supine position and to stabilize the cassette perpendicular to the x-ray beam.

U.S. Pat. No. 5,764,724 to Ohlson discloses a patient support table where an x-ray cassette is supported by a carriage which can move the cassette around the support table enabling pictures to be taken, while the patient is lying down on the support table, with a vertical or horizontal beam path.

Nothing in the prior art provides the unique benefits afforded by the present invention.

### SUMMARY OF THE INVENTION

The patient positioning device and method for obtaining bent knee x-ray views is comprised of a generally horizontal surface on which the patient lies in a supine position such that at least one of the patient's legs is draped over the leg support. The radiolucent leg support is in the general shape of a triangle where one line segment of the triangle supports the patient's lower leg, another line segment of the triangle supports the patient's upper leg and the vertex created by the two line segments determines the angle of flexion of the patient's knee. There is a means for holding a cassette in a vertical position such that a Merchant's View or Sunrise View of one or both of the patient's knees can be obtained. There is another means for holding a cassette in a horizontal position such that a Bent Knee AP View of one or both of the patient's knees can be obtained. A means for holding a cassette in a vertical position such that a Bent Knee Lateral View of the patient's knee can be obtained is also provided.

In the preferred embodiment of this invention, the leg support is made of high density radiolucent foam. A radiolucent material is a material that is almost completely transparent to x-rays. This makes the leg support lightweight and portable. Further, the leg support has no sharp edges so there is no risk of injuring the patient or the technologist while using the device. Additionally, the portion of the radiolucent leg support that contacts the patient is hypoallergenic and nonporous so that the surfaces will not cause allergic reactions and can be easily cleaned with a disinfectant.

The present invention is a portable, lightweight, safe and easy-to-clean patient positioning device and a method of easily positioning the patient on the device. Therefore, the x-ray procedures performed using this device can be done by one technologist in an efficient and safe manner. Also, multiple views of the bent knees can be obtained with little or no repositioning of the patient. Thus, this device represents a significant advancement in the field radiography with respect to bent knee x-rays.

### BRIEF DESCRIPTION OF THE DRAWINGS

FIG. 1 is a perspective view of the patient positioning device.

FIG. 2 is a perspective view of the patient positioning device being used to obtain a Merchant's View of a patient's bent knees.

FIG. 3 is a perspective view of the patient positioning device being used to obtain a Sunrise View of a patient's bent knees.

FIG. 4 is a perspective view of the patient positioning device being used to obtain a Bent Knee AP View of a patient's bent knees.

FIG. 5 is a perspective view of the patient positioning device being used to obtain a Bent Knee Lateral View of a patient's bent knee.

### DETAILED DESCRIPTION

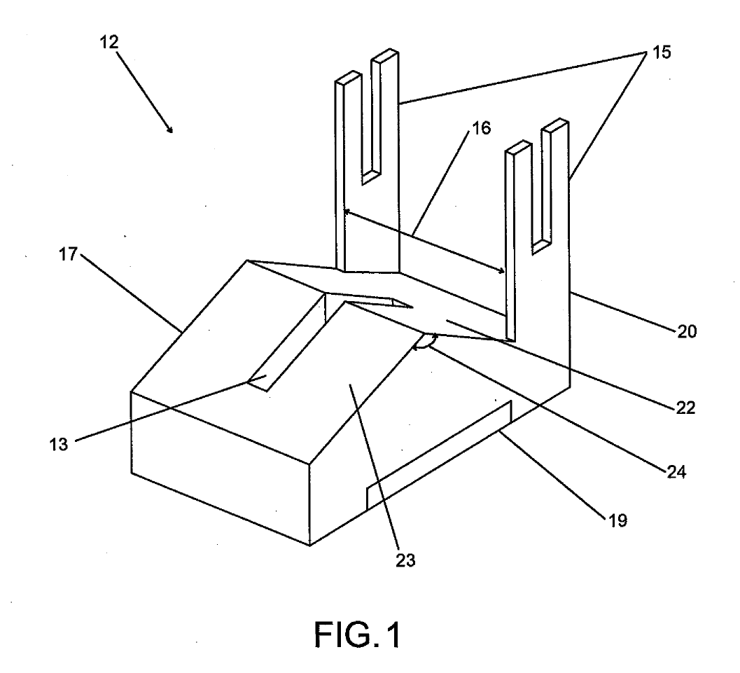

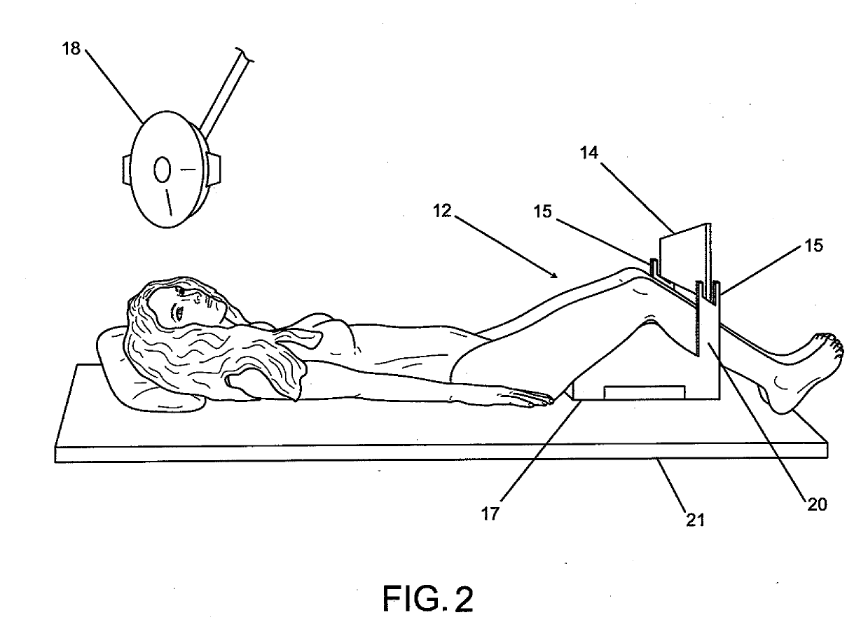

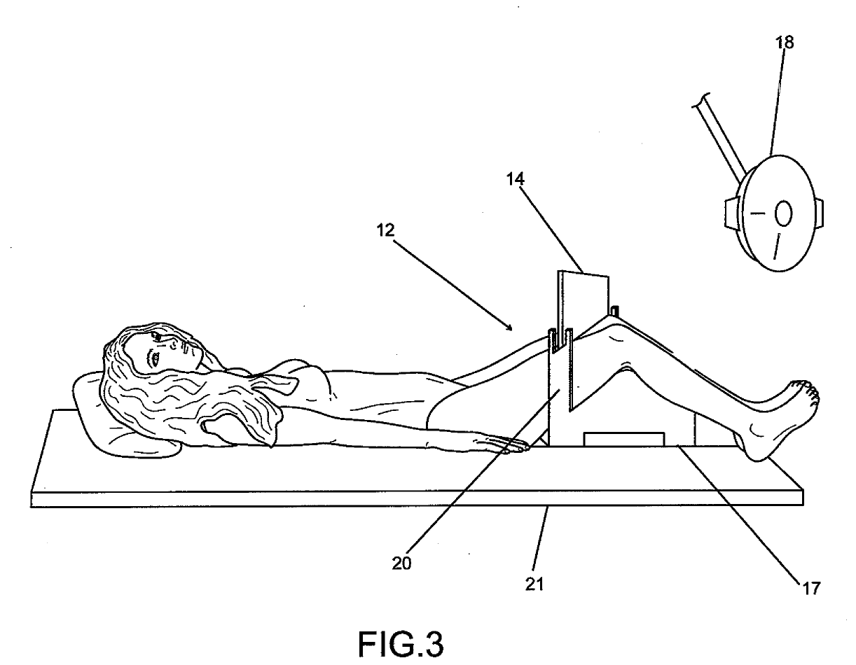

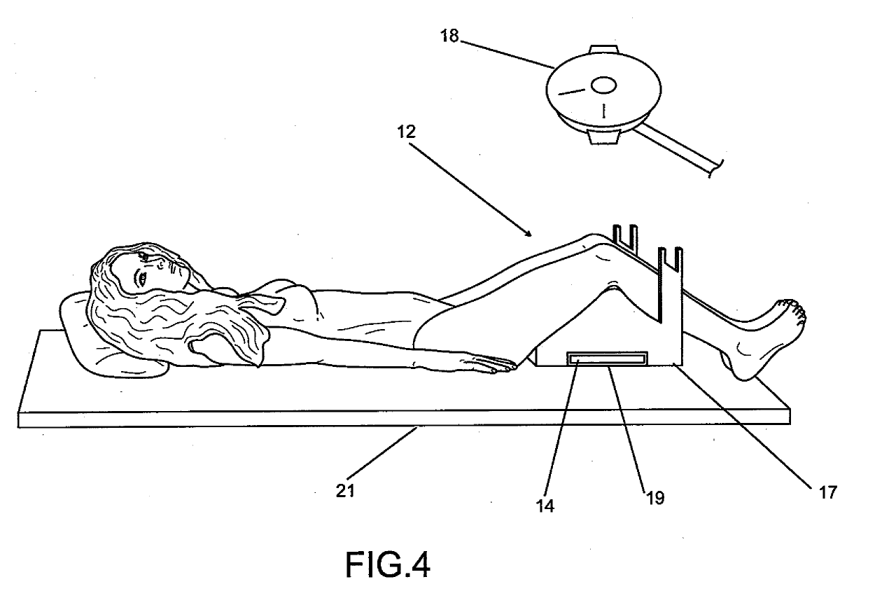

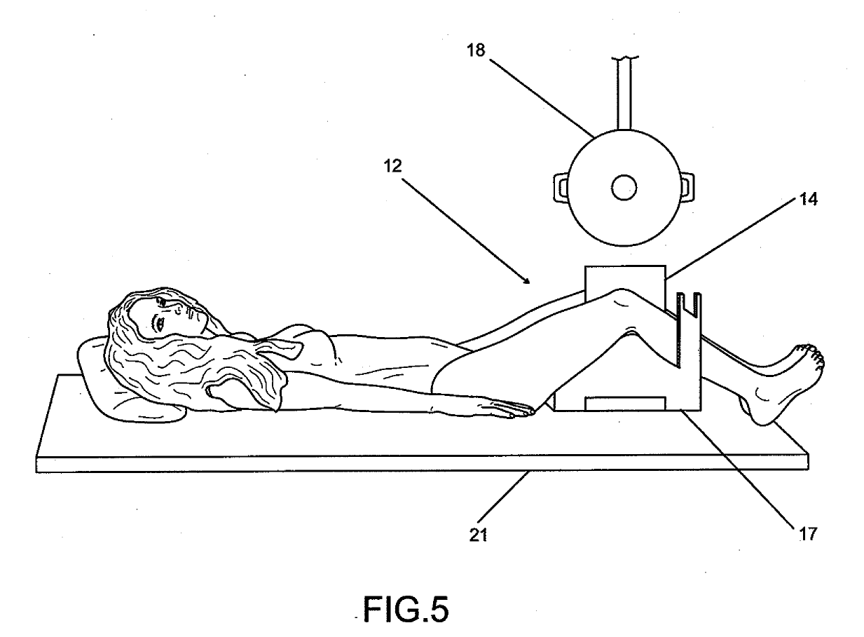

With reference to FIG. 1, the patient positioning device 12 is comprised of a radiolucent leg support 17 in the general shape of a triangle whereby one line segment 22 of the triangle supports the patient's lower leg, another line segment 23 of the triangle supports the patient's upper leg and the vertex 24 created by the two line segments 22, 23 determines the angle of flexion of the patient's knee when the patient's leg is supported by the radiolucent leg support 17. A means 20 for holding a cassette 14 (depicted in FIGS. 2 and 3) in a vertical position such that a Merchant's View or Sunrise View of the patient's knee can be obtained is provided on one end of the leg support 17. A means 19 for holding a cassette 14 (depicted in FIG. 4) in a horizontal position such that a Bent Knee AP View of the patient's knee can be obtained is provided on the bottom of the leg support 17. Another means 13 for holding a cassette 14 (depicted in FIG. 5) in a vertical position such that a Bent Knee Lateral View of the patient's knee can be obtained is provided in the middle of the leg support 17.

In the preferred embodiment of this aspect of this invention, the means 20 for holding a cassette 14 (depicted in FIG. 2) in a vertical position is comprised of two brackets 15 positioned on either side of the leg support 17. Each bracket 15 has a slot within which the cassette 14 (depicted in FIG. 2) can be inserted and held. At least one of the patient's feet extends through the space 16 between the brackets 15.

With reference to FIG. 2, the patient positioning device 12 is placed on a generally horizontal surface 21. The patient is positioned on the surface 21 in a supine position such that at least one of the patient's legs is draped over the radiolucent leg support 17. There is a means 20 for holding a cassette 14 in a vertical position such that a Merchant's View of the patient's knee can be obtained.

To obtain a Merchant's View of at least one of the patient's knees, an x-ray tube 18 horizontally projects an x-ray beam 10 to 15 degrees below the horizontal axis of the patient. The x-ray beam is directed toward the patient's patella from the cranial aspect to the caudal aspect, and is projected onto the generally vertical cassette 14.

With reference to FIG. 3, a Sunrise View of at least one of the patient's knees can be obtained when the patient positioning device 12 and the x-ray tube 18 are horizontally rotated approximately 180 degrees so that the x-ray beam is directed toward the patient's patella from the caudal aspect to the cranial aspect.

With reference to FIG. 4, a Bent Knee AP View of at least one of the patient's knees is obtained by inserting a cassette 14 in the horizontal means 19 and positioning the x-ray tube 18 generally above the patient so that the x-ray beam travels in a downward direction through the knee or knees toward the cassette 14. A variety of Bent Knee AP Views can be obtained by repositioning the x-ray tube 18 to locations above the patient that will yield the particular view desired. In the preferred embodiment of this aspect of the invention, the means 19 for holding a cassette 14 in a horizontal position is comprised of a slot in the leg support 17 within which a cassette 14 can be inserted and held.

With reference to FIG. 5, a Bent Knee Lateral View of a patient's knee can be obtained by inserting a cassette 14 into the vertical means 13 (depicted in FIG. 1) so that the cassette 14 is on the medial side, or inside, of the knee to be x-rayed. The x-ray tube 18 is positioned on the lateral side, or outside, of the knee to be x-rayed. Thus, the x-ray beam travels through the knee joint from the lateral to medial side creating a Bent Knee Lateral View. Once the exposed x-ray cassette is removed for further processing, a new and unexposed cassette 14 can be inserted and the x-ray tube 18 rotated horizontally approximately 180 degrees so that a Bent Knee Lateral View of the patient's other knee can be obtained.

In the preferred embodiment of this aspect invention, the means 13 (depicted in FIG. 1) for holding a cassette 14 in a vertical position is at least one slot located in the leg support 17 that is approximately as long and wide as a cassette 14, or approximately 8 inches, and as deep as necessary to stabilize the cassette 14, or approximately 4 inches. In an alternative embodiment of this invention, more than one means 13 for holding a cassette 14 in a vertical position, or slots, can be located in the leg support 17 in order to accommodate a wider variety of lateral x-ray views.

Also in the preferred embodiment of the present invention, the radiolucent leg support is made of high density foam. This has the advantage of making the leg support more comfortable for the patient. It also makes the leg support much more lightweight and easy to use for the technologist that is performing the x-ray procedure.

In another aspect of the present invention, the leg support has no sharp edges so that there is no risk of injury to the patient or the technologist while using this device.

In another aspect of the present invention, the radiolucent leg support, the means for holding a cassette in a vertical position for a Merchant's or Sunrise View, along with the means for holding a cassette in a horizontal position for a Bent Knee AP View, as well as the means for holding a cassette in a vertical position for a Bent Knee Lateral View are integral.

In still another aspect of the present invention, the portion of the radiolucent leg support that contacts the patient is hypoallergenic so that there is less risk of an allergic reaction.

In yet another aspect of the present invention, the portion of the radiolucent leg support that contacts the patient is nonporous so that the surfaces can be easily cleaned by wiping them down with a disinfectant.

In an alternative embodiment of this invention, by inserting a cassette 14 (depicted in FIG. 5) into the means 13 (depicted in FIG. 1) for holding a cassette in a vertical position for a Bent Knee Lateral View, lateral views of other body parts can be obtained. And by inserting a cassette 14 (depicted in FIG. 4) into the means 19 (depicted in FIG. 4) for holding a cassette in a horizontal position for a Bent Knee AP View, AP views of other body parts can be obtained. For instance, one or both of the patient's ankles can be position on the vertex 24 (depicted in FIG. 1) of the leg support 17 so that AP and lateral ankle views can be obtained. Alternatively, the patient's head can be positioned on the leg support 17 so that AP and lateral views of the skull and c-spine can be obtained.

Using the patient positioning device of the present invention provides significant advantages over devices found in the prior art. First, a whole series of x-ray views can be obtained with minimal repositioning, if any, of the patient. For example, once the patient is positioned for a Merchant's view of both knees, a Bent Knee AP View of the knees along with Bent Knee Lateral Views of each knee can be obtained without repositioning the patient. All that is necessary is to remove exposed cassettes and insert unexposed cassettes to get additional views, without moving the patient. Additionally, the need for the patient or another person to hold a cassette in place and be exposed to additional radiation is completely eliminated.

The device and method of the present invention can also be used in a surgical setting in order to position the patient for surgery on the knees, for instance. And the device makes it easy to obtain x-ray views during surgery as well.

Whereas the figures and description have illustrated and described the concept and preferred embodiment of the present invention, it should be apparent to those skilled in the art that various changes may be made in the form of the invention without affecting the scope thereof. The detailed description above is not intended in any way to limit the broad features or principles of the invention, or the scope of patent monopoly to be granted.

I claim:

1. A device for positioning a patient in order to obtain x-ray views of one or both of the patient's knees, the device comprising:
a generally horizontal surface for supporting the patient;
a radiolucent leg support in the general shape of a triangle whereby one line segment of the triangle supports the patient's lower leg, another line segment of the triangle supports the patient's upper leg, and the vertex created by the two line segments determines the angle of flexion of the patient's knee when the patient's leg is supported by the radiolucent leg support;
a means for holding a cassette in a vertical position such that a Merchant's View of the patient's knee can be obtained;
a means for holding a cassette in a horizontal position such that a Bent Knee AP View of the patient's knee can be obtained; and
a means for holding a cassette in a vertical position such that a Bent Knee Lateral View of the patient's knee can be obtained.

2. The device of claim 1 wherein the radiolucent leg support, the means for holding a cassette in a vertical position such that a Merchant's View of the patient's knee can be obtained, the means for holding a cassette in a horizontal position such that a Bent Knee AP View of the patient's knee can be obtained, and the means for holding a cassette in a vertical position such that a Bent Knee Lateral View of the patient's knee can be obtained are integral.

3. The device of claim 1 wherein the portion of the radiolucent leg support that contacts the patient is hypoallergenic and/or nonporous.

4. A method of positioning a patient in order to obtain a Merchant's View of one or both of the patient's knees, the method comprising the steps of:
providing a generally horizontal surface for supporting the patient;
providing a radiolucent leg support in the general shape of a triangle whereby one line segment of the triangle supports the patient's lower leg, another line segment of the triangle supports the patient's upper leg and the vertex created by the two line segments determines the angle of flexion of the patient's knee when the patient's leg is supported by the radiolucent leg support;
positioning the patient on the surface in a supine position such that at least one of the patient's legs is draped over the leg support; and
positioning a cassette in a vertical position such that a Merchant's View of the patient's knee can be obtained.

5. A method of positioning a patient in order to obtain a Sunrise View of one or both of the patient's knees, the method comprising the steps of:
providing a generally horizontal surface for supporting the patient;
providing a radiolucent leg support in the general shape of a triangle whereby one line segment of the triangle supports the patient's lower leg, another line segment of the triangle supports the patient's upper leg and the vertex created by the two line segments determines the angle of flexion of the patient's knee when the patient's leg is supported by the radiolucent leg support;
positioning the patient on the surface in a supine position such that at least one of the patient's legs is draped over the leg support; and
positioning a cassette in a vertical position such that a Sunrise View of the patient's knee can be obtained.

6. A method of positioning a patient in order to obtain a Bent Knee AP View of one or both of the patient's knees, the method comprising the steps of:
providing a generally horizontal surface for supporting the patient;
providing a radiolucent leg support in the general shape of a triangle whereby one line segment of the triangle supports the patient's lower leg, another line segment of the triangle supports the patient's upper leg and the vertex created by the two line segments determines the angle of flexion of the patient's knee when the patient's leg is supported radiolucent leg support;
positioning the patient on the surface in a supine position such that at least one of the patient's legs is draped over the leg support; and
positioning a cassette in a horizontal position such that a Bent Knee AP View of the patient's knee can be obtained.

7. A method of positioning a patient in order to obtain a Bent Knee Lateral View of one or both of the patient's knees, the method comprising the steps of:
providing a generally horizontal surface for supporting the patient;
providing a radiolucent leg support in the general shape of a triangle whereby one line segment of the triangle supports the patient's lower leg, another line segment of the triangle supports the patient's upper leg and the vertex created by the two line segments determines the angle of flexion of the patient's knee when the patient's leg is supported by the radiolucent leg support;
positioning the patient on the surface in a supine position such that at least one of the patient's legs is draped over the leg support; and
positioning a cassette in a vertical position such that a Bent Knee Lateral View of the patient's knee can be obtained.

8. The method of claim 7 additionally comprising the step of holding the cassette in a vertical position such that a Merchant's View of one or both of the patient's knees can be obtained.

9. The method of claim 7 additionally comprising the step of holding the cassette in a vertical position such that a Sunrise View of one or both of the patient's knees can be obtained.

10. The method of claim 7 additionally comprising the step of holding the cassette in a horizontal position such that a Bent Knee AP View of one or both of the patient's knees can be obtained.
